(19) United States
(12) Patent Application Publication
(10) Pub. No.: US 2026/0269365 A1
(43) Pub. Date: Sep. 10, 2026

(54) POLYMER FLUID CONDUIT ARRANGEMENTS FOR TRACTION BATTERY PACK

(71) Applicant: Ford Global Technologies, LLC, Dearborn, MI (US)

(72) Inventors: Antony George Schepak, Howell, MI (US); Patrick Daniel Maguire, Ann Arbor, MI (US); Yi Zhang, Ann Arbor, MI (US); Dennis Manning, Novi, MI (US); Daniel Benjamin Kok, Ann Arbor, MI (US); Mohammadreza Eftekhari, Novi, MI (US); Deanna Marie Winton Hoffman, Ann Arbor, MI (US)

(21) Appl. No.: 19/304,666

(22) Filed: Aug. 20, 2025

Related U.S. Application Data
(60) Provisional application No. 63/766,671, filed on Mar. 4, 2025.

(51) Int. Cl. H01M 10/6557; H01M 10/613; H01M 10/625; H01M 10/6566; H01M 10/6568; H01M 50/213; H01M 50/249

(52) U.S. Cl. CPC H01M 10/6557; H01M 10/613; H01M 10/625; H01M 10/6566; H01M 10/6568; H01M 50/213; H01M 50/249

(57) ABSTRACT

A traction battery pack may include a plurality of battery cells. A traction battery pack may include a fluid conduit arranged adjacent the battery cells. The fluid conduit may define a passageway configured to guide thermal exchange fluid relative to the battery cells. The fluid conduit may be made of polymer.

### RELATED APPLICATIONS

This application claims the benefit of U.S. Provisional Application No. 63/766,671, filed Mar. 4, 2025, the entirety of which is herein incorporated by reference.

### TECHNICAL FIELD

This disclosure relates generally to a polymer fluid conduit of a traction battery pack of an electrified vehicle. This disclosure includes a number of arrangements, including intermediate supports for the polymer fluid conduit, and manifold assemblies configured to direct flow relative to the polymer fluid conduit.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack, including: a plurality of battery cells; and a fluid conduit arranged adjacent the battery cells, wherein the fluid conduit defines a passageway configured to guide thermal exchange fluid relative to the battery cells, and wherein the fluid conduit is made of polymer.

In some aspects, the techniques described herein relate to a traction battery pack, wherein: the plurality of battery cells includes a first group of battery cells and a second group of battery cells, and the fluid conduit is arranged between the first and second groups of battery cells.

In some aspects, the techniques described herein relate to a traction battery pack, wherein: the fluid conduit includes a first conduit section and a second conduit section, the first and second conduit sections are made of polymer.

In some aspects, the techniques described herein relate to a traction battery pack, wherein: a first side of the first conduit section faces the first group of battery cells, and a second side of the first conduit section faces the second conduit section and partially defines the passageway, and a first side of the second conduit section faces the first conduit section and partially defines the passageway, and a second side of the second conduit section faces the second group of battery cells.

In some aspects, the techniques described herein relate to a traction battery pack, wherein: the fluid conduit includes an intermediate support between the first and second conduit sections, and the intermediate support includes a plurality of columns and a plurality of standoffs projecting from the columns.

In some aspects, the techniques described herein relate to a traction battery pack, wherein the intermediate support is hingedly connected to one of the first and second conduit sections.

In some aspects, the techniques described herein relate to a traction battery pack, wherein: the plurality of columns project between the second face of the first conduit section and the first face of the second conduit section, and each of the standoffs directly contacts both the second face of the first conduit section and the first face of the second conduit section.

In some aspects, the techniques described herein relate to a traction battery pack, wherein: the intermediate support includes a base, and the columns project from the base.

In some aspects, the techniques described herein relate to a traction battery pack, wherein the passageway of the first conduit section is bound by a first sealed connection between the first conduit section and the second conduit section, a second sealed connection between the first conduit section and the base, and a third sealed connection between the second conduit section and the base.

In some aspects, the techniques described herein relate to a traction battery pack, wherein: a width dimension of the passageway varies along a length of the passageway, and the columns and standoffs are present in locations where the width of the passageway is greater than at an adjacent location of the passageway.

In some aspects, the techniques described herein relate to a traction battery pack, wherein: the first side of the first conduit section exhibits a plurality of cavities, each cavity of the first conduit section is configured to receive a portion of one of the battery cells of the first group, the second side of the second conduit section exhibits a plurality of cavities, and each cavity of the second conduit section is configured to receive a portion of one of the battery cells of the second group.

In some aspects, the techniques described herein relate to a traction battery pack, wherein: each of the cavities of the first conduit section is substantially arcuate and is concave from a perspective of a battery cell of the first group, and each of the cavities of the second conduit section is substantially arcuate and concave from a perspective of a battery cell of the second group.

In some aspects, the techniques described herein relate to a traction battery pack, wherein: each of the cavities of the first conduit section is arranged between two first projections of the first conduit section, each of the cavities of the second conduit section is arranged between two second projections of the second conduit section, and the first and second projections each exhibit a plurality of recesses.

In some aspects, the techniques described herein relate to a traction battery pack, further including: a manifold assembly configured to direct thermal exchange fluid to the passageway.

In some aspects, the techniques described herein relate to a traction battery pack, wherein: the fluid conduit is a first fluid conduit, and the traction battery pack further includes a second fluid conduit arranged between the second group of battery cells and a third group of battery cells, wherein the second fluid conduit defines a passageway configured to guide thermal exchange fluid between the second and third groups of battery cells, and wherein the second fluid conduit is made of polymer, and the manifold assembly is configured to direct thermal exchange fluid to or from the passageways of the first and second fluid conduits.

In some aspects, the techniques described herein relate to a traction battery pack, wherein: the manifold assembly is a first manifold assembly and is arranged adjacent a first end of the traction battery pack, the traction battery pack further includes a second manifold assembly arranged adjacent a second end of the traction battery pack opposite the first end.

In some aspects, the techniques described herein relate to a battery pack, wherein: the first manifold assembly is configured to divide a flow of thermal exchange fluid and direct the divided flow into the passageways of the first fluid conduit and the second fluid conduit in parallel, and the second manifold assembly is configured to combine the divided flow of thermal exchange fluid and direct the combined flow to a downstream location.

In some aspects, the techniques described herein relate to a traction battery pack, wherein: the first manifold assembly is configured to direct a flow of thermal exchange fluid into the passageway of the first fluid conduit, the battery pack is configured such the flow expelled from the first fluid conduit enters the second fluid conduit, and the second manifold assembly is configured to receive the flow expelled from the second fluid conduit.

In some aspects, the techniques described herein relate to a traction battery pack, wherein the plurality of battery cells are cylindrical battery cells.

In some aspects, the techniques described herein relate to a method, including: directing thermal exchange fluid through a passageway defined by a fluid conduit of a traction battery pack, wherein the fluid conduit is arranged between a first group of battery cells and a second group of battery cells, wherein the fluid conduit is made of polymer.

### BRIEF DESCRIPTION OF THE DRAWINGS

FIG. 1 schematically illustrates an electrified vehicle.

FIG. 2 illustrates a plurality of cylindrical battery cells relative to an electrified vehicle.

FIG. 3 illustrates a traction battery pack from an exterior perspective.

FIG. 4 is a view similar to FIG. 3, with a top wall of the traction battery pack removed, and with one of the manifold assemblies drawn translucently.

FIG. 5 illustrates an example fluid conduit.

FIG. 6 is a close-up view of an end of the example fluid conduit.

FIG. 7 illustrates an intermediate support of the example fluid conduit.

FIG. 8 is a top view of a portion of the example fluid conduit.

FIG. 9 illustrates an embodiment in which the intermediate support is integrally molded with a section of the fluid conduit.

FIG. 10 is a cross-sectional view taken along line 10-10 from FIG. 4, and illustrates a portion of a manifold assembly in more detail.

FIG. 11 is a perspective view of the traction battery pack with alternative manifold assemblies.

FIG. 12 illustrates an example configuration of an end wall of the traction battery pack.

FIG. 13 illustrates an alternative manifold configuration relative to the end wall of FIG. 12.

FIG. 14 illustrates an alternative arrangement of the first and second fluid conduit sections.

FIG. 15 illustrates an alternative arrangement of the passageway relative to a fluid conduit, with a portion of one of the fluid conduit sections cut away.

FIG. 16 illustrates the passageway arrangement of FIG. 15 adjacent an opposite end of the fluid conduit, with one of the fluid conduit sections shown semi-transparently.

### DETAILED DESCRIPTION

This disclosure relates generally to a polymer fluid conduit of a traction battery pack of an electrified vehicle. This disclosure includes a number of arrangements, including intermediate supports for the polymer fluid conduit, and manifold assemblies configured to direct flow relative to the polymer fluid conduit. Among other benefits, which will be appreciated from the description below, this disclosure facilitates routing of thermal exchange fluid relative to cylindrical battery cells, while fluidly isolating the thermal exchange fluid from the cells, and while providing structural support to the battery cells. The disclosure further enables a desired flow path of the thermal exchange fluid (i.e., in parallel or series) relative to rows of battery cells. The disclosure further maintains substantially constant fluid velocity within the fluid conduit. These and other benefits will be appreciated from the below.

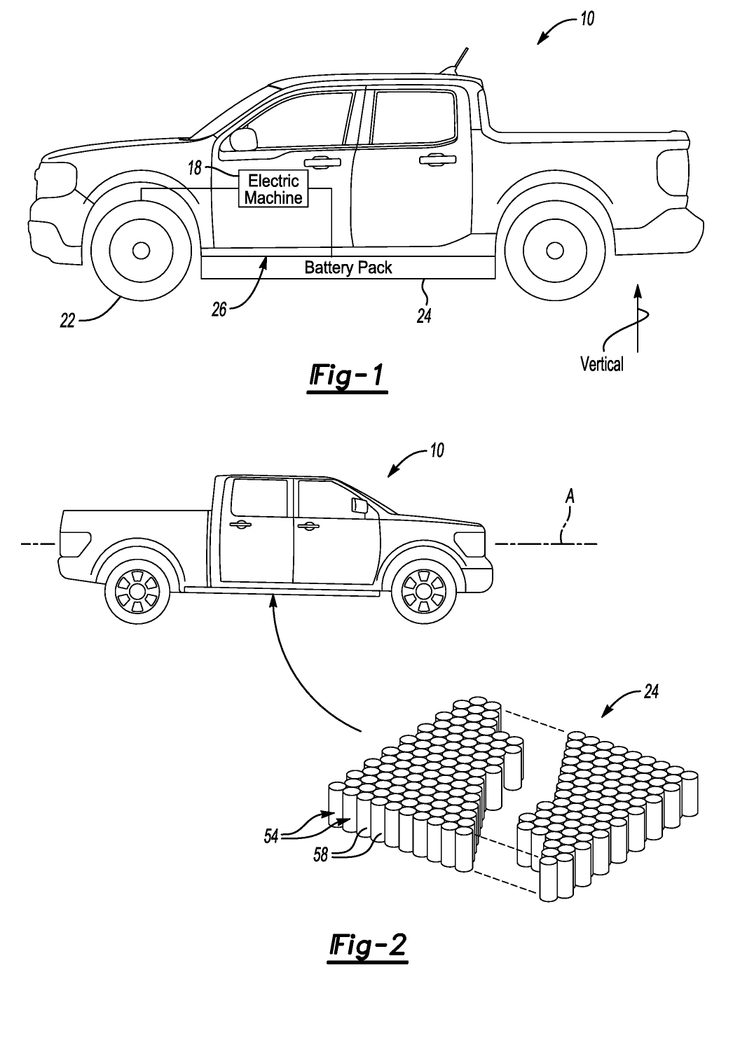

With reference to FIG. 1, an electrified vehicle 10 includes a battery pack 24, an electric machine 18, and wheels 22. The battery pack 24 powers the electric machine 18, which can convert electrical power to mechanical power to drive the wheels 22. The battery pack 24 is thus a traction battery pack.

The battery pack 24 is, in the exemplary embodiment, secured to an underbody 26 of the electrified vehicle 10. The battery pack 24 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference to FIGS. 2-4, the battery pack 24 includes a plurality of individual battery cells 54. The battery cells 54 each include an outer case 58. The outer cases 58 can be a metal or metal alloy. The outer cases 58 are cylindrical, or substantially cylindrical, in this example. The battery cells 54 may be referred to as cylindrical battery cells. The battery cells 54 include terminals configured to electrically couple to other battery cells 54 and/or busbars, as examples, adjacent a common side thereof, which in this example is a top side.

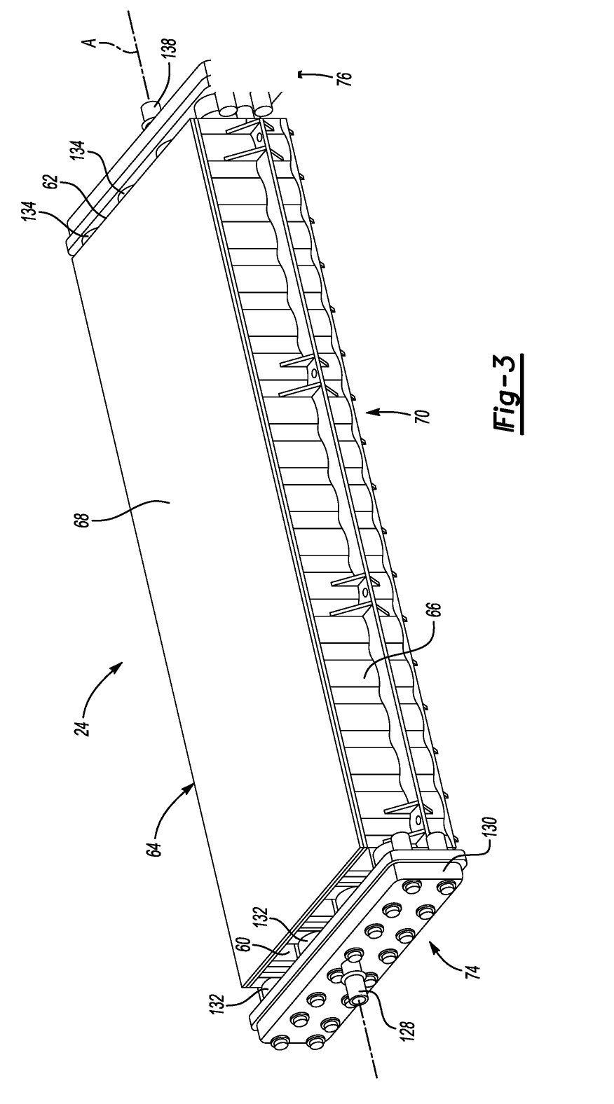

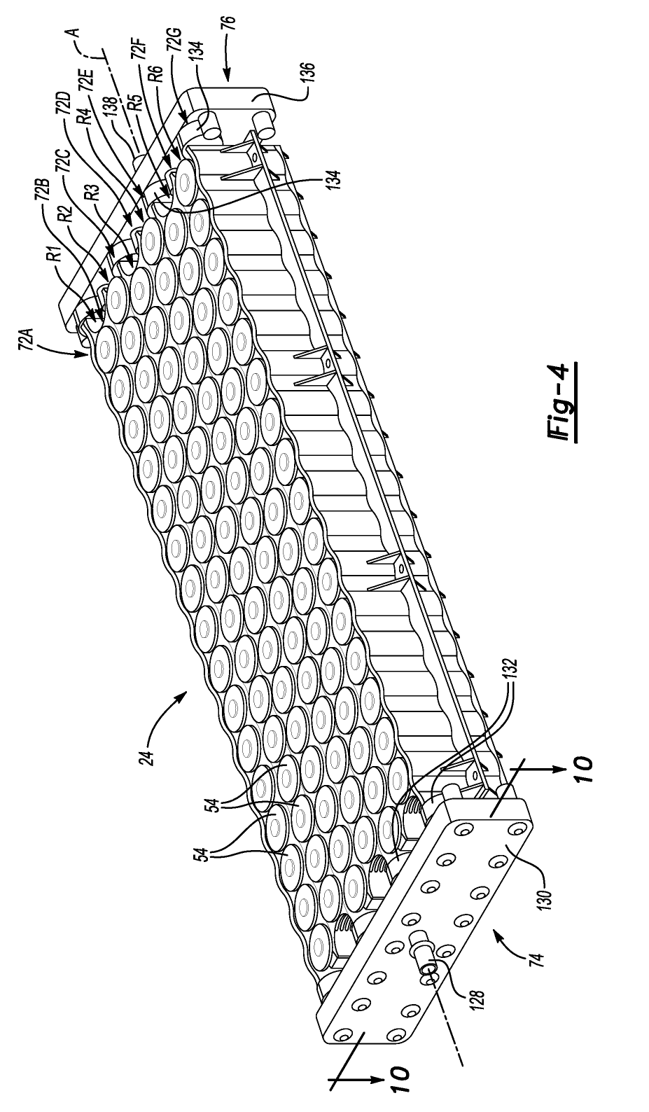

With specific reference to FIG. 3, the battery pack 24 includes a first end wall 60, a second end wall 62 arranged on an opposite side of the battery pack 24 as the first end wall 60, a first side wall 64 extending along a first side of the battery pack 24 between the first and second end walls 60, 62, and a second side wall 66 extending between the first and second end walls 60, 62 along a second side of the battery pack 24 opposite the first side wall 64. The battery pack 24 further includes a top wall 68 and a bottom wall 70. The top wall 68 is removed in FIG. 4 for ease of viewing the arrangement of battery cells 54.

As shown in FIG. 4, the battery cells 54 are arranged in groups, which here are rows R1-R6. Rows R1-R6 extend generally from first end wall 60 to second end wall 62. While there are six rows R1-R6 in this example, this disclosure extends to battery packs with a different number of rows. Further, this disclosure is not limited to the particular number battery cells 54 in a particular row.

Rows R1-R6 are each generally parallel to one another and, optionally, a longitudinal axis A of the vehicle 56, in this example. Adjacent rows R1-R6 are staggered relative to one another to enable closer packaging of the battery cells 54, which results in the battery cells 54 having a generally honeycomb pattern. In this example, the battery cells 54 are arranged such that the electrical connections between adjacent battery cells 54 are made adjacent the top wall 68, and a venting arrangement is arranged adjacent bottom wall 70.

The battery pack 24 includes a plurality of fluid conduits 72A-72G, each of which is configured to direct thermal exchange fluid, such as coolant, water, etc., therein to transfer thermal energy between the thermal exchange fluid and the battery cells 54. In a particular example, the thermal exchange fluid is configured to absorb or distribute heat from the battery cells 54. Each of the fluid conduits 72A-72G individually, or a group of some or all of the fluid conduits 72A-72G collectively, may be referred to as a cooling jacket.

The fluid conduits 72A-72G are arranged relative to manifold assemblies 74, 76, which will be discussed below, to facilitate a flow of thermal exchange fluid relative to the fluid conduits 72A-72G. While two manifold assemblies 74, 76 are shown in FIG. 4, this disclosure extends to examples with one or more manifold assemblies. The manifold assembly or assemblies may enable flow of thermal exchange fluid within the fluid conduits 72A-72G in series or in parallel, as examples.

The manifold assemblies 74, 76 and fluid conduits 72A-72G enable transfer of thermal energy between the thermal exchange fluid and the battery cells 54 without directly bringing the thermal exchange fluid into contact with the battery cells 54. In this regard, the manifold assemblies 74, 76 and fluid conduits 72A-72G may be considered hermetically sealed. Each row R1-R6 of battery cells 54 may have a fluid conduit on both sides thereof as in FIG. 4, or alternatively each row R1-R6 of battery cells 54 may have a fluid conduit on only one side thereof.

The fluid conduits 72A-72G are made of polymer, and in a particular example are made entirely of polymer. The fluid conduits 72A-72G can therefore be relatively easily manufactured using known techniques, such as injection molding. The fluid conduits 72A-72G exhibit relatively high strength and heat transfer properties. The fluid conduits 72A-72G are also relatively light weight.

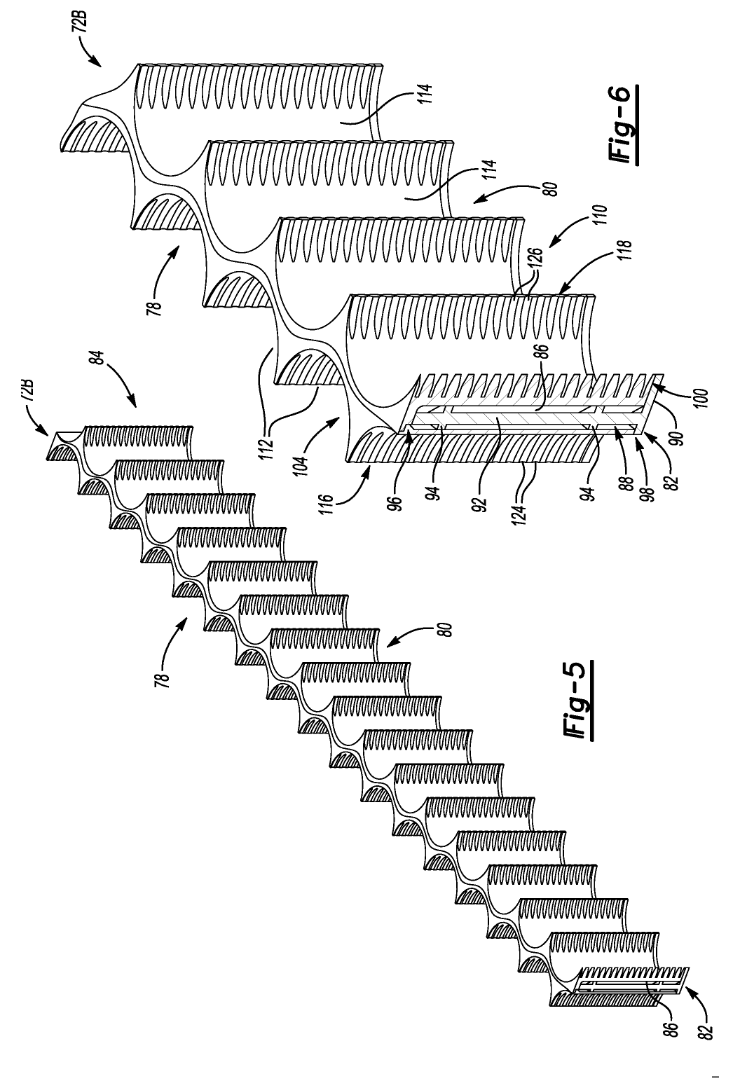

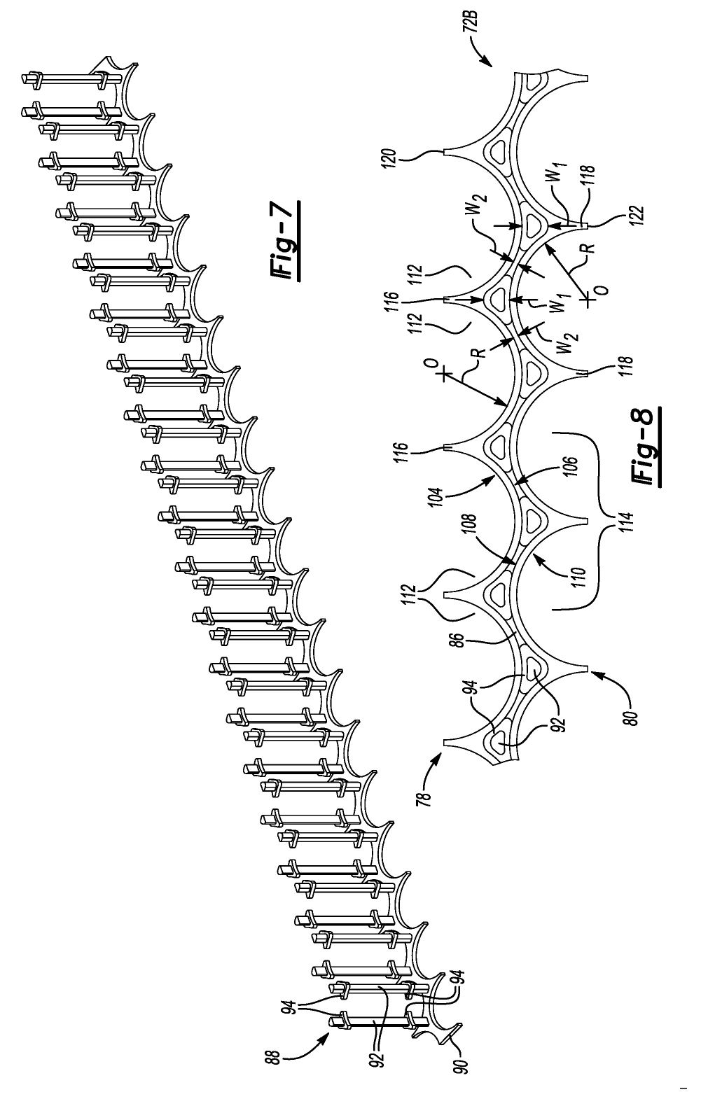

An example fluid conduit 72B is illustrated across FIGS. 5-9. While fluid conduit 72B is shown, it should be understood that fluid conduit 72B is representative of each of the fluid conduits 72A-72G. The fluid conduits 72A and 72G, in an example, are configured to provide the side walls 64, 66, as will be discussed below. In this regard, the fluid conduits 72A, 72G may be referred to as exterior fluid conduits. Further, in another example, side walls 64, 66 are provided by structures separate from fluid conduits 72A, 72G.

The fluid conduit 72B is arranged between row R1 and row R2. Fluid conduit 72B is configured to facilitate relatively tight packaging between the battery cells 54 of rows R1 and R2 while directing thermal exchange fluid relative to the battery cells 54 and providing structural support to the battery pack 24.

In this example, fluid conduit 72B includes a first conduit section 78 and a second conduit section 80. The first and second conduit sections 78, 80 extend the entire distance between a first end 82 of the fluid conduit 72B and a second end 84 of the fluid conduit 72B opposite the first end 82. In this example, the first and second ends 82, 84 are configured to sealingly engage with the end walls 60, 62, respectively, to facilitate a fluid-tight connection with manifold assemblies 74, 76. The fluid conduit 72B includes a passageway 86 within which thermal exchange fluid can flow between the first and second ends 82, 84. The fluid conduit 72B is open adjacent first and second ends 82, 84, at which points thermal exchange fluid can enter or exit the passageway 86.

In addition to the first and second conduit sections 78, 80, the fluid conduit 72B in this example further includes an intermediate support 88 (FIG. 6) arranged generally between the first and second conduit sections 78, 80. The intermediate support 88 includes a base 90, a plurality of columns 92 projecting from the base 90, and a plurality of standoffs 94 projecting from the columns 92. The intermediate support 88 and corresponding base 90, columns 92, and standoffs 94 are not required in all examples—in those examples, the first and second conduit sections 78, 80 would include a substantially empty interior region without any flow optimizers. The base 90 extends along an entirety of a length of the fluid conduit 72B, from first end 82 to second end 84, in this example. Columns 92 project from the base 90 and into the passageway 86. The columns 92 are spaced-apart from one another along a length of the fluid conduit 72B. The standoffs 94 project horizontally from columns 92 and are spaced-apart from one another along the length of the columns 92. While each column 92 includes two standoffs 94 in this example, this disclosure extends to columns with one or more standoffs. Alternatively, standoffs could be formed as ribs projecting from first and/or second conduit sections 78, 80, in which case the first and second conduit sections 78, 80 may not need a separate intermediate support 88. While referred to as a “support,” the intermediate support 88 may, in some examples, primarily serve a function other than providing structural support, such as influencing fluid flow.

Each of the first conduit section 78, second conduit section 80, and intermediate support 88 is formed entirely of polymer in this example. The first conduit section 78, second conduit section 80, and intermediate support 88 can each be separately formed by injection molding and then connected together in a fluid-tight manner, such as by welding and/or using adhesives. Forming the first and second conduit sections 78, 80 in such a manner permits the cavities 112, 114 to exhibit a minimal to no draft angle moving vertically within the cavities 112, 114, such that the cavities 112, 114 closely conform to the battery cells 54, which are cylindrical in one example, which leads to efficient thermal energy transfer.

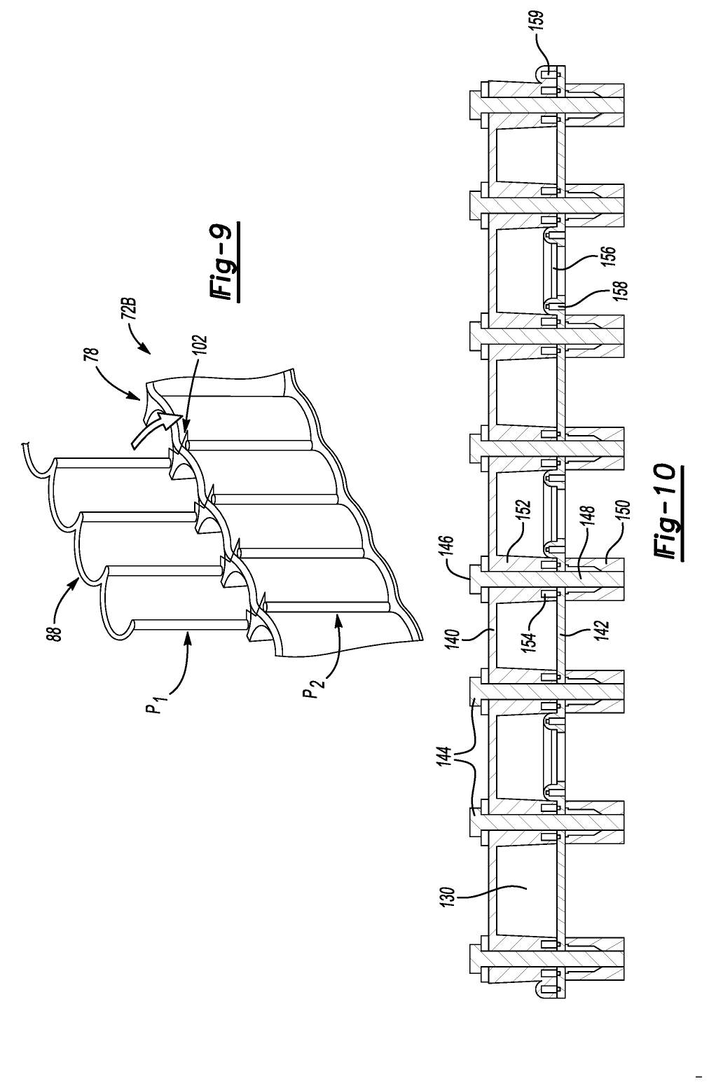

In another example, as shown in FIG. 9, intermediate support 88 could be formed integrally with first conduit section 78, with the intermediate support 88 being initially formed in position P1, for example, and, after forming, rotated into the position P2 of FIG. 6 via a hinge 102. Hinge 102 may be a relatively narrow portion of material connecting first conduit section 78 and intermediate support 88. Intermediate support 88 is shown without standoffs or a base in FIG. 9. The intermediate support 88 could include both standoffs and a base, however. While shown relative to first conduit section 78, intermediate support 88 could be formed integrally with second conduit section 80 in a similar manner. FIG. 14 illustrates another configuration in which the intermediate support 88 is integrally formed with the first conduit section 78, such as by injection molding. FIG. 14 further illustrates first and second sealed connections 99, 101, in which a projection of the second conduit section 80 vertically overlaps with a groove of the first conduit section 78 to facilitate welding the first and second conduit sections 78, 80 together.

With reference to FIG. 6, the passageway 86 is bound by a first sealed connection 96 between the first conduit section 78 and the second conduit section 80, a second sealed connection 98 between the first conduit section 78 and the base 90, and a third sealed connection between the second conduit section 80 and the base 90. Sealed connections 96, 98, 100 may be provided by welding, adhesive, and/or any other known technique for joining polymer structures in a fluid-tight manner. Example welding techniques include laser welding, radio frequency (RF) welding, vibration welding, hot plate welding, hot gas welding, etc.

With reference to FIG. 8, the first conduit section 78 includes a first side 104 facing the row R1, and a second side 106 facing the second conduit section 80 and at least partially defining the passageway 86. The second conduit section 80 includes a first side 108 facing the first conduit section 78 and at least partially defining the passageway 86, and a second side 110 facing the row R2.

The first side 104 of the first conduit section 78 exhibits a plurality of cavities 112, and the second side 110 of the second conduit section 80 exhibits a plurality of cavities 114. Each cavity 112 is configured to receive a portion of one of the battery cells 54 of row R1, and each cavity 114 is configured to receive a portion of one of the battery cells 54 of row R2. Each cavity 112, 114 is substantially arcuate and exhibits a shape conforming to an exterior of the battery cells 54.

In an example, first side 104 directly contacts battery cells 54 of row R1, and second side 110 directly contacts battery cells 54 of the second group R2. In another example, a layer of adhesive and/or a layer of thermal interface material (TIM).

Each cavity 112, 114 is substantially semi-circular when viewed from a perspective of the top wall 68, for example, as in FIG. 8. In particular, each cavity 112, 114 exhibits an arc substantially equal to a half circle, defined by a constant radius R having origin O. Radius R follows the contour of the first side 104 and second side 110. Cavities 112 are concave from a perspective of the battery cells 54 of row R1, and cavities 114 are concave from a perspective of battery cells 54 of row R2. Fluid conduits 72A, 72G, which provide side walls 64, 66, respectively, may exhibit a first or second conduit section that lacks the cavities of the fluid conduit 72B, because the fluid conduits 72A, 72G each exhibit one side that does not face a row of battery cells 54.

Cavities 112 are arranged between adjacent projections 116 of the first conduit section 78, and cavities 114 are arranged between adjacent projection 118 of the second conduit section 80. The projections 116, 118 exhibit end walls 120, 122, respectively, laterally (i.e., up-and-down, in FIG. 8) aligned with origins O. Projections 116 of the first conduit section 78 are aligned, relative to a length dimension of the fluid conduit 72B, with an origin O of one of the cavities 114. Likewise, projections 118 of the second conduit section 80 are aligned, relative to a length dimension of the fluid conduit 72B, with an origin O of one of the cavities 112. Such staggering facilitates relatively tight packaging of the battery cells 54.

As shown in FIG. 6, projections 116, 118 each exhibit a plurality of spaced-apart recesses 124, 126, respectively, along a vertical dimension thereof. Recesses 124, 126 may be configured as notches or indentations. Recesses 124, 126 reduce the overall weight of the fluid conduit 72B without compromising strength. Recesses 124, 126 resist the formation of depressions in the surfaces of the first and second conduit sections 78, 80, as the respective sections cool following injection molding, for example. This disclosure is not limited to the height or spacing of the recesses 124, 126.

With reference to FIG. 8, a width dimension of the passageway 86 varies along a length thereof (i.e., from left-to-right in FIG. 8). The passageway 86 exhibits a relatively wide width W1 at locations where an origin O of one of the cavities 112, 114 is aligned, relative to the length of the fluid conduit 72B, with one of the projections 116, 118. The passageway 86 exhibits a relatively narrow width W2 at locations between the relatively wide width W1 locations. In this example, the columns 92 and standoffs 94 are arranged in the locations of relatively wide width W1. As such, the columns 92 and standoffs 94 fill some volume of the passageway 86, to make the volume of the passageway 86 more consistent between the locations exhibiting a wider width W1 and a narrower width W2. Doing so results in a more consistent velocity of thermal exchange fluid as the thermal exchange fluid flows along the passageway 86.

The columns 92 project into passageway 86 between second side 106 and first side 108. Further, the standoffs 94 each directly contact both second side 106 and first side 108. As such, the standoffs 94 increase the rigidity of the battery pack 24. In other examples, standoffs 94 do not directly contact sides 106, 108.

The columns 92 and/or standoffs 94 may be formed to include, or exhibit the shape of, a turbulator or a flow disturber to introduce an intended fluid dynamic effect into the thermal exchange fluid, as desired.

Various manifold assemblies come within the scope of this disclosure. With reference back to FIGS. 3 and 4, manifold assembly 74 is configured to distribute thermal exchange fluid to the fluid conduits 72A-72G, in parallel. The manifold assembly 74 includes an inlet 128 that receives the thermal exchange fluid, and a plenum 130 that acts as a central chamber to evenly distribute the fluid. The plenum 130 is fluidly and sealingly coupled to conduits 132 that direct fluid from plenum 130, through end wall 60, and to a respective one of the fluid conduits 72A-72G. Each of the conduits 132 is aligned with one of the fluid conduits 72A-72G, establishing a fluid-tight connection. Thermal exchange fluid flows from the plenum 130, through the conduits 132, which are arranged in parallel with one another, to simultaneously direct the thermal exchange fluid into the fluid conduits 72A-72G, in parallel.

Downstream of the fluid conduits 72A-72G, fluid is expelled into manifold assembly 76, which is configured substantially similar to manifold assembly 74, including conduits 134, plenum 136, and an outlet 138. Plenum 136 combines the parallel flows from conduits 134 and directs the combined flow to outlet 138.

FIG. 10 illustrates the plenum 130 in more detail. The plenum 130 is defined by a first housing section 140 and a second housing section 142. The first and second housing sections 140, 142 are coupled together via fasteners 144. Fasteners 144 each exhibit a head 146 configured to abut first housing section 140 and a threaded shank 148 configured to engage with a nut 150 on an opposite side of the second housing section 142 as the first housing section 140. Threaded shanks 148 are surrounded by cylindrical projections 152 extending within plenum 130 from the first housing section 140 to the second housing section 142. A seal 154 is provided between projections 152 and the second housing section 142. Outlets 156 leading to conduits 132 are also provided with seals 158. Another seal 159 is provided about a perimeter of the first housing section 140 and establishes a fluid tight seal between the first and second housing sections 140, 142.

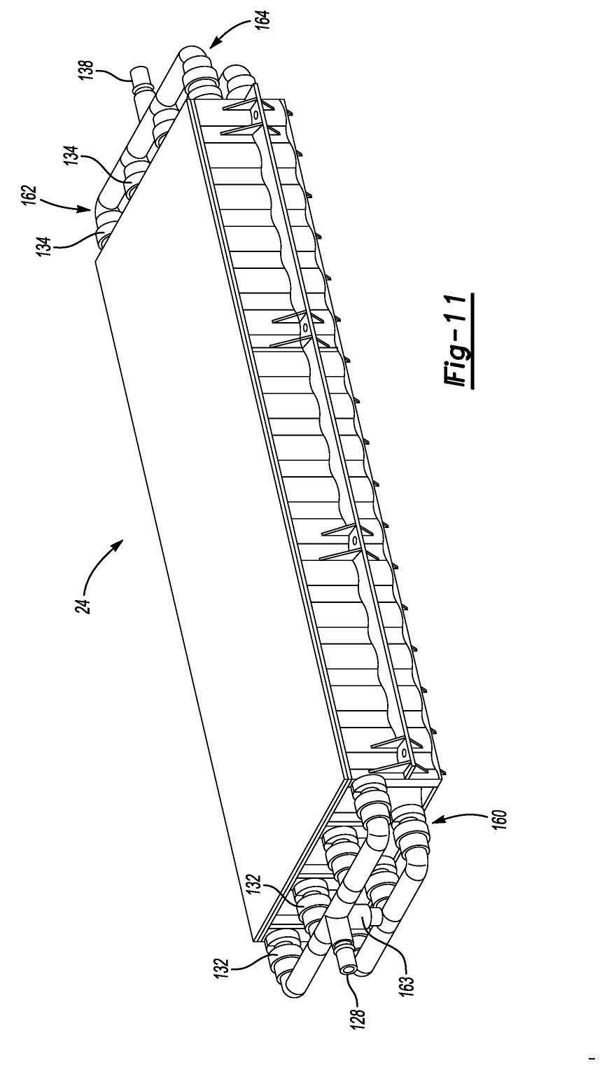

Manifold assemblies 160, 162 (FIG. 11) are also configured to distribute thermal exchange fluid to the fluid conduits 72A-72G, in parallel. The manifold assembly 160 is substantially similar to manifold assembly 74, with the exception being that the plenum 130 is replaced by an arrangement of conduits 163. Likewise, manifold assembly 160 is configured substantially similar to manifold assembly 76, with the exception that conduits 164 replace plenum 136.

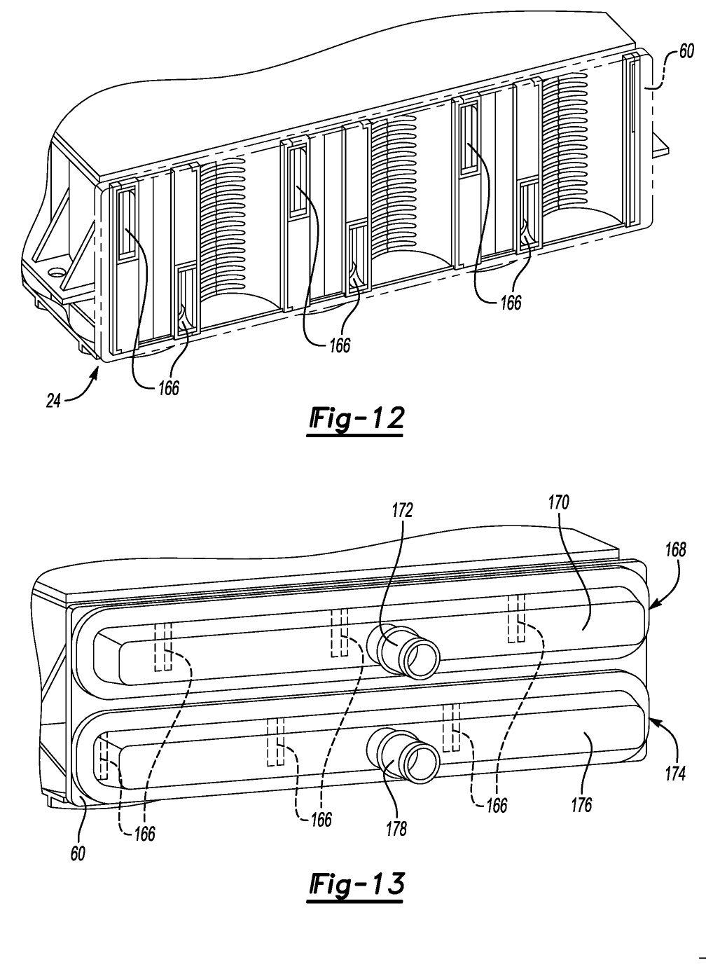

An exemplary arrangement of end wall 60 will now be described with reference to FIG. 12. End wall 62 may be configured similarly. End wall 62 includes through-slots 166, each of which is laterally (i.e., in the left and right direction in FIG. 12) aligned with a respective one of the fluid conduits 72A-72G, and in particular aligned with a passageway corresponding to that fluid conduit (e.g., passageway 86). Slots 166, in this example, exhibit a height equal to only a portion of a height of a passageway (e.g., passageway 86) with which the slots 166 are aligned. The slots 166 may exhibit a greater or lesser height. Downstream of the slots 166, the thermal exchange fluid expands and fills an entire height of the respective passageway. In this example, adjacent slots 166 are arranged in an alternating arrangement, with one slot 166 arranged adjacent a top of the wall 60, and the immediately adjacent slot arranged adjacent a bottom of the wall 60, and so on. The alternating arrangement facilitates a desired flow path of thermal exchange fluid within the battery pack 24, and/or facilitates packaging of the conduits 132. Conduits 132 are each configured to connect to one of the slots 166, in this example, in a fluid tight manner. This arrangement of walls 60, 62 may apply to any of the manifold assemblies herein.

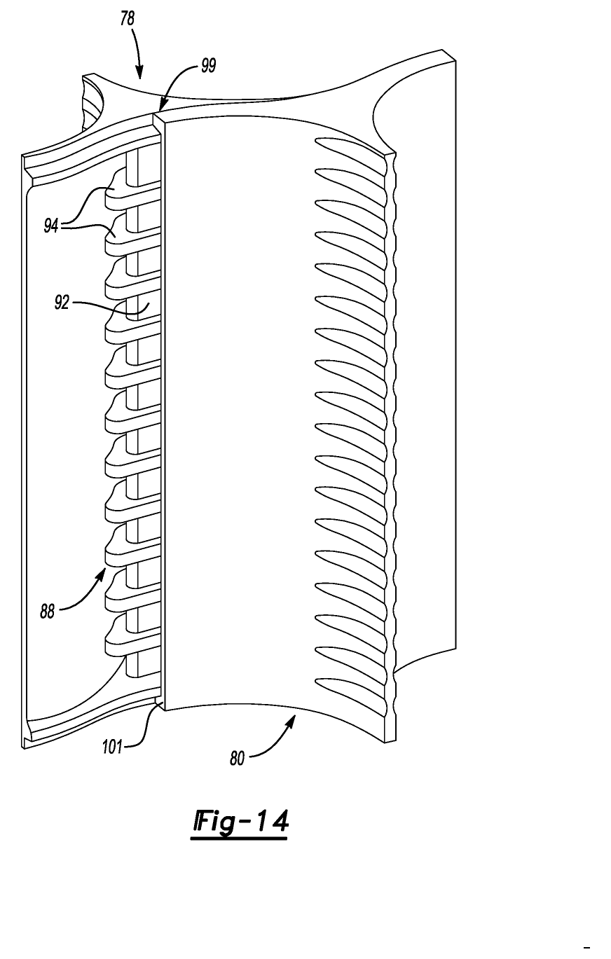

The alternating arrangement of slots 166 may be useful when directing thermal exchange fluid between one of the fluid conduits 72A-72G to another fluid conduit 72A-72G in series. As shown in FIG. 13, a first manifold assembly 168 is sealingly engaged with wall 60 and includes a plenum 170 configured to cover slots 166 adjacent the top of wall 60. Plenum 170 distributes fluid from inlet port 172 to the slots 166 adjacent the top of the wall 60 in parallel. Fluid expelled from the fluid conduits aligned with slots 166 is turned adjacent wall 62 and enters an adjacent fluid conduit and is returned to manifold assembly 174, which includes plenum 176 covering slots 166 adjacent the bottom of the wall 60. Plenum 176 directs flow to outlet port 178. The arrangement of FIG. 13 may be useful if packaging constraints are relatively tight, as two manifold assemblies are able to be mounted to one end of the battery pack 24.

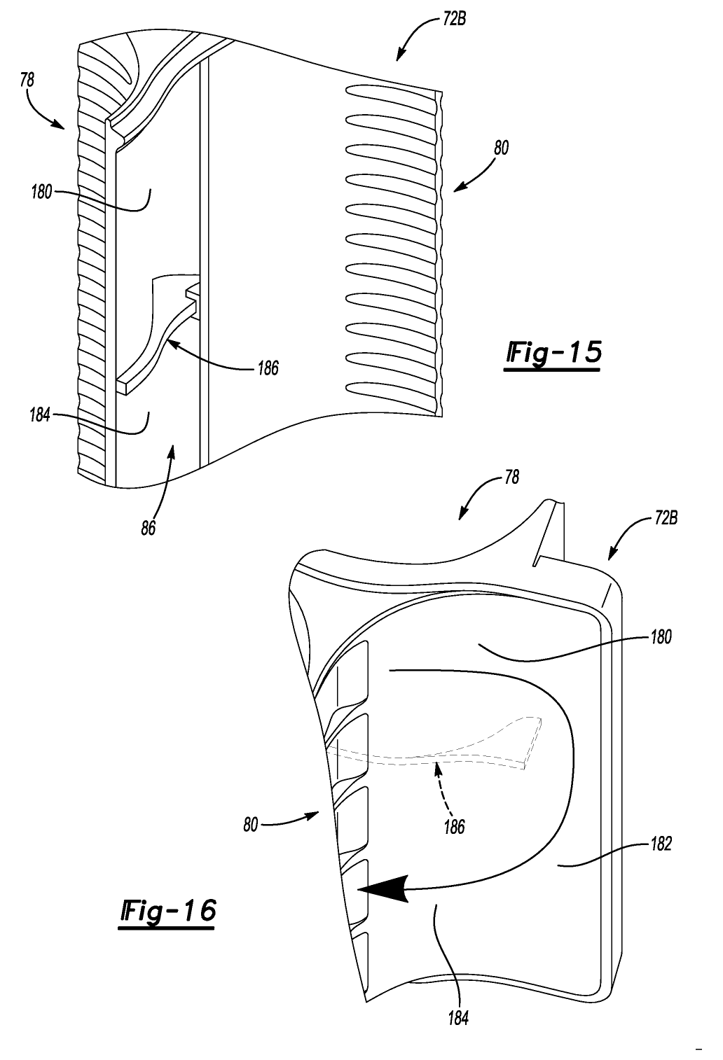

In another embodiment, shown in FIGS. 15 and 16, each of the fluid conduits 72A-72G is configured to permit parallel flows of fluid in opposite directions, and is further configured to turn flow within the fluid conduit itself. With reference to fluid conduit 72B, which is representative of fluid conduits 72A-72G, the fluid conduit 72B is arranged relative to a manifold assembly such that fluid flows into fluid conduit 72B via the manifold assembly, along a top section 180 of the passageway 86, turns adjacent the opposite end of the fluid conduit 72B within a plenum 182, and flows back toward the manifold assembly along a bottom section 184 of the passageway 86. The top and bottom sections 180, 184 of the passageway are fluidly separated along the entire length of the fluid conduit 72B, with the exception of the plenum 182, by a tongue-and-groove connection 186, in this example, with the tongue being provided by one of the fluid conduit sections 78, 80, and the groove being provided by the other of the fluid conduit sections 78, 80. Other arrangements may provide the fluid separation between top and bottom sections 180, 184, such as a lap joint.

It should be understood that terms such as “about,” “substantially,” and “generally” are not intended to be boundaryless terms, and should be interpreted consistent with the way one skilled in the art would interpret those terms. Directional terms should be interpreted consistent with the context that those terms are used.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A traction battery pack, comprising:
a plurality of battery cells; and
a fluid conduit arranged adjacent the battery cells, wherein the fluid conduit defines a passageway configured to guide thermal exchange fluid relative to the battery cells, and wherein the fluid conduit is made of polymer.

2. The traction battery pack as recited in claim 1, wherein:
the plurality of battery cells includes a first group of battery cells and a second group of battery cells, and
the fluid conduit is arranged between the first and second groups of battery cells.

3. The traction battery pack as recited in claim 2, wherein:
the fluid conduit includes a first conduit section and a second conduit section,
the first and second conduit sections are made of polymer.

4. The traction battery pack as recited in claim 3, wherein:
a first side of the first conduit section faces the first group of battery cells, and a second side of the first conduit section faces the second conduit section and partially defines the passageway, and
a first side of the second conduit section faces the first conduit section and partially defines the passageway, and a second side of the second conduit section faces the second group of battery cells.

5. The traction battery pack as recited in claim 4, wherein:
the fluid conduit includes an intermediate support between the first and second conduit sections, and
the intermediate support includes a plurality of columns and a plurality of standoffs projecting from the columns.

6. The traction battery pack as recited in claim 5, wherein the intermediate support is hingedly connected to one of the first and second conduit sections.

7. The traction battery pack as recited in claim 5, wherein:
the plurality of columns project between the second face of the first conduit section and the first face of the second conduit section, and
each of the standoffs directly contacts both the second face of the first conduit section and the first face of the second conduit section.

8. The traction battery pack as recited in claim 5, wherein:
the intermediate support includes a base, and
the columns project from the base.

9. The traction battery pack as recited in claim 8, wherein the passageway of the first conduit section is bound by a first sealed connection between the first conduit section and the second conduit section, a second sealed connection between the first conduit section and the base, and a third sealed connection between the second conduit section and the base.

10. The traction battery pack as recited in claim 5, wherein:
a width dimension of the passageway varies along a length of the passageway, and
the columns and standoffs are present in locations where the width of the passageway is greater than at an adjacent location of the passageway.

11. The traction battery pack as recited in claim 4, wherein:
the first side of the first conduit section exhibits a plurality of cavities,
each cavity of the first conduit section is configured to receive a portion of one of the battery cells of the first group,
the second side of the second conduit section exhibits a plurality of cavities, and
each cavity of the second conduit section is configured to receive a portion of one of the battery cells of the second group.

12. The traction battery pack as recited in claim 11, wherein:
each of the cavities of the first conduit section is substantially arcuate and is concave from a perspective of a battery cell of the first group, and
each of the cavities of the second conduit section is substantially arcuate and concave from a perspective of a battery cell of the second group.

13. The traction battery pack as recited in claim 12, wherein:
each of the cavities of the first conduit section is arranged between two first projections of the first conduit section,
each of the cavities of the second conduit section is arranged between two second projections of the second conduit section, and
the first and second projections each exhibit a plurality of recesses.

14. The traction battery pack as recited in claim 2, further comprising:
a manifold assembly configured to direct thermal exchange fluid to the passageway.

15. The traction battery pack as recited in claim 14, wherein:
the fluid conduit is a first fluid conduit, and
the traction battery pack further comprises a second fluid conduit arranged between the second group of battery cells and a third group of battery cells, wherein the second fluid conduit defines a passageway configured to guide thermal exchange fluid between the second and third groups of battery cells, and wherein the second fluid conduit is made of polymer, and
the manifold assembly is configured to direct thermal exchange fluid to or from the passageways of the first and second fluid conduits.

16. The traction battery pack as recited in claim 15, wherein:
the manifold assembly is a first manifold assembly and is arranged adjacent a first end of the traction battery pack,
the traction battery pack further comprises a second manifold assembly arranged adjacent a second end of the traction battery pack opposite the first end.

17. The battery pack as recited in claim 16, wherein:
the first manifold assembly is configured to divide a flow of thermal exchange fluid and direct the divided flow into the passageways of the first fluid conduit and the second fluid conduit in parallel, and
the second manifold assembly is configured to combine the divided flow of thermal exchange fluid and direct the combined flow to a downstream location.

18. The traction battery pack as recited in claim 16, wherein:
the first manifold assembly is configured to direct a flow of thermal exchange fluid into the passageway of the first fluid conduit,
the battery pack is configured such the flow expelled from the first fluid conduit enters the second fluid conduit, and
the second manifold assembly is configured to receive the flow expelled from the second fluid conduit.

19. The traction battery pack as recited in claim 1, wherein the plurality of battery cells are cylindrical battery cells.

20. A method, comprising:
directing thermal exchange fluid through a passageway defined by a fluid conduit of a traction battery pack, wherein the fluid conduit is arranged between a first group of battery cells and a second group of battery cells, wherein the fluid conduit is made of polymer.
